(19) United States
(12) Patent Application Publication
(10) Pub. No.: US 2014/0221039 A1
(43) Pub. Date: Aug. 7, 2014

(54) Smart Radio System

(71) Applicant: Access Device Integrated Communications Corp., Taichung City (TW)

(72) Inventors: Shu-Chun Liao, New Taipei City (TW); Ding-Kai Wang, Taipei City (TW); Chung-Kuang Chen, New Taipei City (TW)

(73) Assignee: Access Device Integrated Communications Corp., Taichung City (TW)

(21) Appl. No.: 14/164,266

(22) Filed: Jan. 27, 2014

Related U.S. Application Data
(60) Provisional application No. 61/761,705, filed on Feb. 7, 2013.
(60) Provisional application No. 61/822,926, filed on May 14, 2013.

(30) Foreign Application Priority Data
Nov. 18, 2013 (TW) 102141909

(51) Int. Cl. H04M 1/02; H04W 4/10

(52) U.S. Cl. CPC H04M 1/0202; H04W 4/10
USPC 455/550.1

(57) ABSTRACT

A smart radio system includes a mobile device and a radio device. The mobile device includes a signal processing module for processing a received signal to be outputted as a processed result or processing signals generated by a signal source to be a transmission signal; a user interface for generating a control signal; and a first transmission module for receiving the received signal to be transmitted to the signal processing module or outputting the transmission signal according to the control signal. The radio device includes a real-time communication module for receiving the received signal or transmitting the transmission signal via wireless transmission; and a second transmission module for transmitting the transmission signal outputted by the first transmission module to the real-time communication module or transmitting the received signal received by the real-time communication module to the first transmission module.

### CROSS REFERENCE TO RELATED APPLICATIONS

This application claims the benefits of U.S. Provisional Application No. 61/761,705, filed on Feb. 7, 2013 and entitled “Smart Walkie-Talkie System” and U.S. Provisional Application No. 61/822, 926, filed on May 14, 2013 and entitled “Technology that Connects Common Bluetooth Headset with Two-way Radio for PTT Communication”, the contents of which are incorporated herein.

### BACKGROUND OF THE INVENTION

1. Field of the Invention

The present invention relates to a smart radio system and method thereof, and more particularly, to a smart radio system and method thereof for integrating a mobile device and a radio device.

2. Description of the Prior Art

Conventionally, a walkie-talkie (more formally known as a handheld transceiver) is a convenient mobile communication device to provide two-way communication as well as real-time communication, and has the major characteristic of a half-duplex channel, i.e. only one radio signal transmits at a time, though any number can listen. In the meanwhile, a “push-to-talk” (PTT) button is needed to be pressed while the user transmits the radio signal. The population utilizing the multi-function mobile device has increased, and more choices for mobile devices have been provided, such that the user starts to anticipate that more software/hardware functions can be adaptively integrated/realized in the same mobile device.

Therefore, it has become an important issue to provide another smart radio system integrating the walkie-talkie as well as the mobile device.

### SUMMARY OF THE INVENTION

It is therefore an objective of the present invention to provide a smart radio system which integrates a mobile device and a radio device to provide the real-time and two-way communication.

A smart radio system comprises a mobile device, comprising a signal processing module for processing a received signal to output a processed result of the received signal, or processing signals generated by a signal source to generate a transmission signal; a user interface for generating a control signal; and a first transmission module, coupled between the user interface and the signal processing module, for receiving the received signal to be transmitted to the signal processing module, or outputting the transmission signal according to the control signal; and a radio device, comprising a real-time communication module for receiving the received signal or transmitting the transmission signal via a wireless transmission; and a second transmission module, coupled between the real-time communication module and the first transmission module, for transmitting the transmission signal outputted by the first transmission module to the real-time communication module, or transmitting the received signal received by the real-time communication module to the first transmission module.

A method for operating a smart radio system, which comprises a radio device and a mobile device and both are coupled to each other. The method comprises a first operation and a second operation. The first operation comprises a signal processing module of the mobile device processing signals generated by a signal source to generate a transmission signal; a user interface of the mobile device generating a control signal; a first transmission module outputting the transmission signal according to the control signal; a second transmission module of the radio device receiving the transmission signal outputted by the first transmission module, and transmitting the transmission signal to a real-time communication module of the radio device; and the real-time communication module transmitting the transmission signal via a wireless transmission. The second operation comprises the real-time communication module receiving the received signal, and transmitting the received signal to the second transmission module; the second transmission module transmitting the received signal received by the real-time communication module to the first transmission module; the first transmission module receiving the received signal, and transmitting the received signal to the signal processing module; and the signal processing module receiving the received signal, and outputting a processed result of the received signal.

A radio system coupled to a Bluetooth earphone module, the radio system comprises a transformation module for receiving an audio signal to generate a transformation signal; and a Bluetooth module for receiving the transformation signal to generate a Bluetooth transmission signal to the Bluetooth earphone module, such that the Bluetooth earphone module obtains the audio signal.

A method for a radio system, which is coupled to a Bluetooth earphone module and comprises a transformation module and a Bluetooth module, comprises the transformation module receiving an audio signal to generate a transformation signal; and the Bluetooth module receiving the transformation signal to generate a Bluetooth transmission signal to the Bluetooth earphone module, such that the Bluetooth earphone module obtains the audio signal; wherein the transformation signal is realized as a digital input signal or an analogy input signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a schematic diagram of a smart radio system according to an embodiment of the invention.

FIG. 1B illustrates a block diagram of the smart radio system according to an embodiment of the invention.

FIG. 2 illustrates a schematic diagram of a signal transmission between the mobile device and the radio device according to an embodiment of the invention.

FIG. 3 illustrates a schematic diagram of another signal transmission between the mobile device and the radio device according to an embodiment of the invention.

FIG. 4 illustrates a schematic diagram of another signal transmission between the mobile device and the radio device according to an embodiment of the invention.

FIG. 5 illustrates a schematic diagram of utilizing a dialing history record module for recording the communication of the mobile device and the radio device according to an embodiment of the invention.

FIG. 6 illustrates a schematic diagram of a signal transmission between the smart radio system and other radio devices according to an embodiment of the invention.

FIG. 7 illustrates a schematic diagram of another signal transmission between the smart radio system and other radio devices according to an embodiment of the invention.

FIG. 8 illustrates a schematic diagram of a signal transmission between different smart radio systems according to an embodiment of the invention.

FIG. 9 illustrates a schematic diagram of a radio device and a Bluetooth module according to an embodiment of the invention.

FIG. 10 illustrates a schematic diagram of combination of the mobile device and the radio device according to an embodiment of the invention.

FIG. 11 illustrates a flow chart of a first operation process according to an embodiment of the invention.

FIG. 12 illustrates a flow chart of a second operation process according to an embodiment of the invention.

FIG. 13 illustrates a schematic diagram of another radio system being capable of integrating with the smart radio system according to an embodiment of the invention.

FIG. 14 illustrates a flow chart of an operation process according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

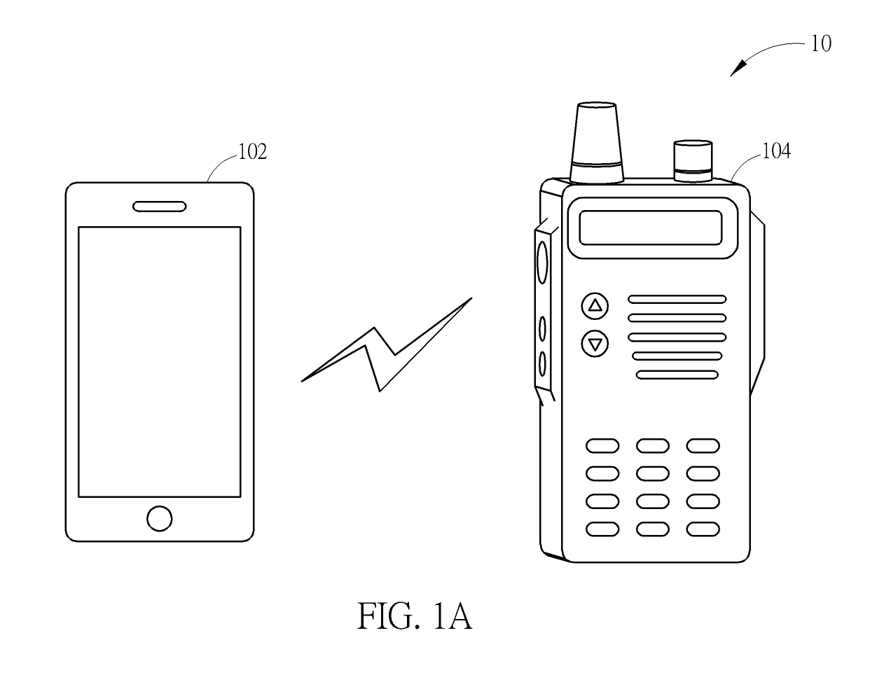

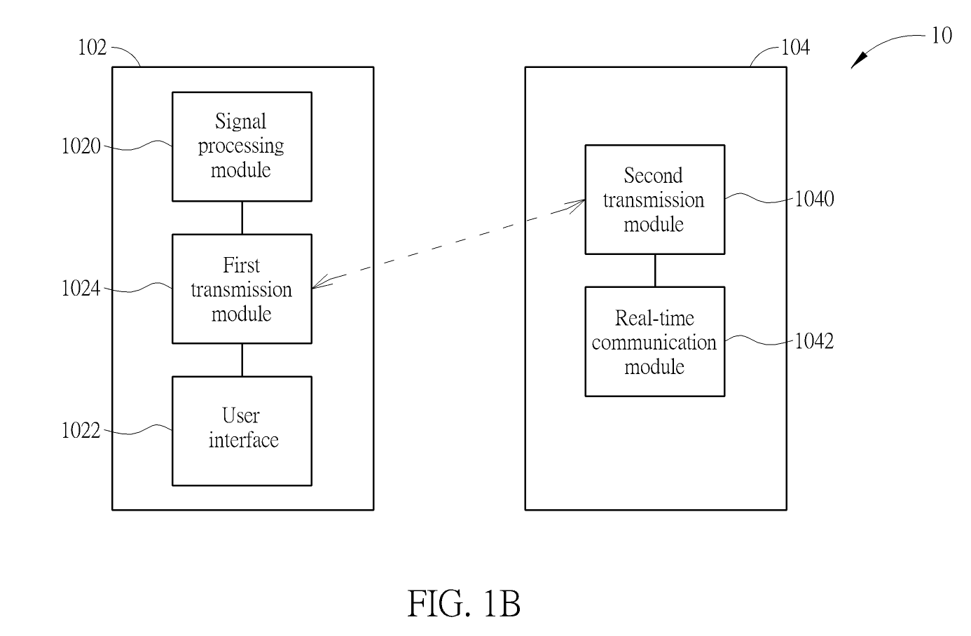

Please refer to FIG. 1A and FIG. 1B, wherein FIG. 1A illustrates a schematic diagram of a smart radio system 10 according to an embodiment of the invention, and FIG. 1B illustrates a block diagram of the smart radio system 10 according to an embodiment of the invention. As shown in FIG. 1A, the smart radio system 10 includes a mobile device 102 and a radio device 104, and the mobile device 102 and the radio device 104 are coupled to each other via a wireless transmission way or a wired transmission way. The wireless transmission way can be realized via a Bluetooth technique, and the wired transmission way can be realized via the Universal Serial Bus (USB), Lighting ports, or transmission lines for transmitting related information, which is not limiting the scope of the invention. As shown in FIG. 1B, the mobile device 102 includes a signal processing module 1020, a user interface 1022 and a first transmission module 1024, and the radio device 104 includes a second transmission module 1040 and a real-time communication module 1042. Accordingly, the embodiment of the invention provides the wireless transmission way or the wired transmission way to establish a short-distance communication between the mobile device 102 and the radio device 104, and the mobile device 102 and the radio device 104 are electrically coupled to each other for interchanging related information.

In detail, in the embodiment, the first communication module 1024 is coupled between the signal processing module 1020 and the user interface 1022, and the second transmission module 1040 is coupled to the real-time communication module 1042, such that the first transmission module 1024 and the second transmission module 1040 establish the wireless/wired connection. For discussing operations of receiving radio signals, after establishing the wireless/wired connection, the real-time communication module 1042 can receive signals (e.g. audio signals or GPS information) via the wireless transmission way, and the second transmission module 1040 can transmit the received signals from the real-time communication module 1042 to the signal processing module 1020 via the first transmission module 1024 after receiving the signals, such that the signal processing module 1020 can process the received signals and correspondingly output a processed result (e.g. outputting audio signals or displaying GPS information). For discussing operations of transmitting the radio signals, the signal processing module 1020 can process signals generated by a signal source (e.g. an audio source or a GPS information source) to be a transmission signal. In the meanwhile, the user can utilize the user interface 1022 to generate a control signal, such that the first transmission module 1024 can transmit the transmission signal to the second transmission module 1040 according to the control signal generated by the user interface 1022. Accordingly, the real-time communication module 1042 can transmit the transmission signal via the wireless transmission way.

In other words, the smart radio system 10 of the invention provides two operational modes. One operational mode is that the mobile device 102 outwardly transmits the transmission signal via the radio device 104, i.e. the smart radio system 10 is operated for speaking or transmitting signals, and the other operational mode is that the radio device 104 receives signals from an external signal source, e.g. an external radio device, to be transferred to the mobile device 102, i.e. the smart radio system 10 is operated for listening or receiving signals. The mobile device 102 of the invention can be operated to support the second generation mobile communication system, such as Global System for Mobile Communications (GSM), the Enhanced Data rates for GSM Evolution (EDGE) or the General Packet Radio Service (GPRS), the third generation mobile communication system, such as the Universal Mobile Telecommunications System (UMTS), the Long Term Evolution (LTE) or the LTE-Advanced (LTE-A), or the fourth generation mobile communication system, which is not limiting the scope of the invention.

Furthermore, the first transmission module 104 of the module device 102 and the second transmission module 1040 of the radio device 104 not only process a power adjustment operation for the transmission signal, but also process a coding/decoding operation, an encryption/decryption operation or a correction operation, which is also in the scope of the invention. Also, the real-time communication module 1042 can adaptively communicate with another radio device (not shown in the figure) for transmitting radio signals, wherein the radio signal has the following transmission conditions, such as the frequency band of the range from 467.5125 MHz to 467.6750 MHz, a channel gap of 12.5 thousand Hz, and a transmission power of 300 milli-Watt. Different transmission ways, such as dual-frequency transmission, high power transmission, or long-distance transmission, for the radio signal to be communicated with another radio device can be adaptively selected to process the real-time and two-way communication, which is not limiting the scope of the invention.

Moreover, the signal processing module 1020 of the embodiment can be an audio processing module, such as a speaker unit, an amplifier or a microphone, and the user can operate the signal processing module 1020 of the mobile device 102 to generate an audio signal, such as an analog signal. Under such circumstance, the transmission signal as well as the received signal in the embodiment can be the audio signal generated by the user. Accordingly, the signal processing module 1020 can transform the transmission signal as well as the received signal to be a digital signal for transmitting between the first transmission module 1024 and the second transmission module 1040, and the received signal or the transmission signal utilized by the real-time communication module 1042 can be realized as another digital signal corresponding to another radio device.

Noticeably, as shown in FIG. 1, the radio device 104 is configured with a fixed operational interface with a displaying panel, to provide basic selections of switching/adjusting transmission channels, transmission frequencies, transmission audio volume or transmission power, and to display related information of the currently utilizing channel. Certainly, the embodiment shown in FIG. 1A can be adaptively modified for different requirements. For example, the operational interface with one display panel of the radio device 104 can be realized as a replaceable panel, or a user interface of the mobile device 102 can be utilized to replace the operational interface of the radio device 104, which is also in the scope of the invention. For simplicity, the following description for the smart radio system 10 can be selected to have the radio device 104 being configured with the fixed user interface.

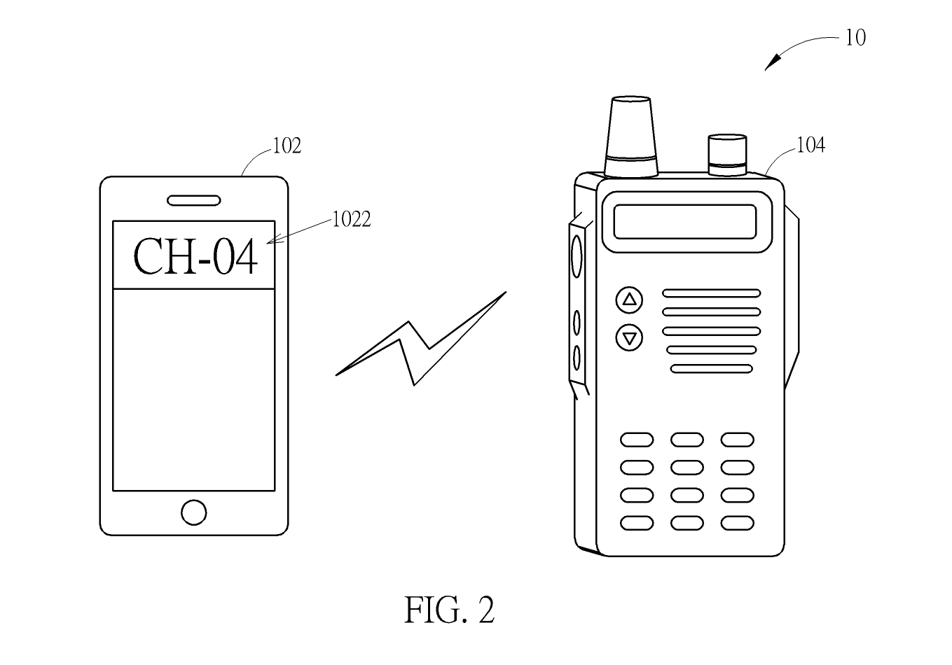

Please refer to FIG. 2, which illustrates a schematic diagram of a signal transmission between the mobile device 102 and the radio device 104 according to an embodiment of the invention. As shown in FIG. 2, a displaying panel of the mobile device 102 demonstrates/shows a user interface 1022, and the user interface 1022 includes a touch panel and at least one virtual button displayed on the touch panel. Accordingly, the user can touch the at least one virtual button on the touch panel to correspondingly generate the control signal. Preferably, the user interface 1022 further includes a frequency adjustment unit (or a frequency adjustment virtual button) to generate a frequency adjustment signal, such that the user can utilize the mobile device 102 via the radio device 104 to adjust the operational frequency of the real-time communication module 1042. Also, the user interface 1022 further includes an audio adjustment unit (or an audio adjustment virtual button) to generate an audio adjustment signal, such that the user can adaptively adjust an outputted audio volume of the mobile device 102. In other words, the mobile device 102 of the embodiment can be utilized to control related transmission of the radio device 104, and to correspondingly adjust related transmission parameters of the radio device 104 according to different requirements.

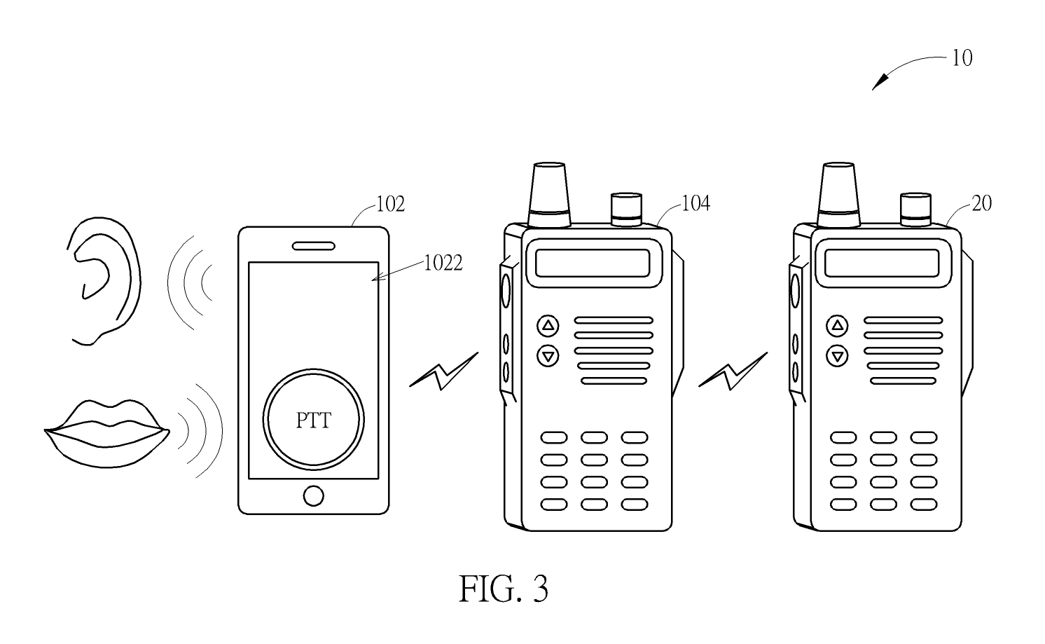

Please refer to FIG. 3, which illustrates a schematic diagram of another signal transmission between the mobile device 102 and the radio device 104 according to an embodiment of the invention. As shown in FIG. 3, the user interface 1022 of the mobile device 102 further includes a push-to-talk (PTT) button, and the PTT button can also be disposed on the user interface 1022 via a software application (or pre-installed before the mobile device 102 is sold on the market), which is not limiting the scope of the invention. When the user touches/presses the PTT button, the real-time communication of the radio device 104 can be correspondingly triggered, or the two-way communication between the radio device 104 and another radio device 20 can also be anticipated, such that the mobile device 102 can adaptively control the audio signal transmission of the radio device 104.

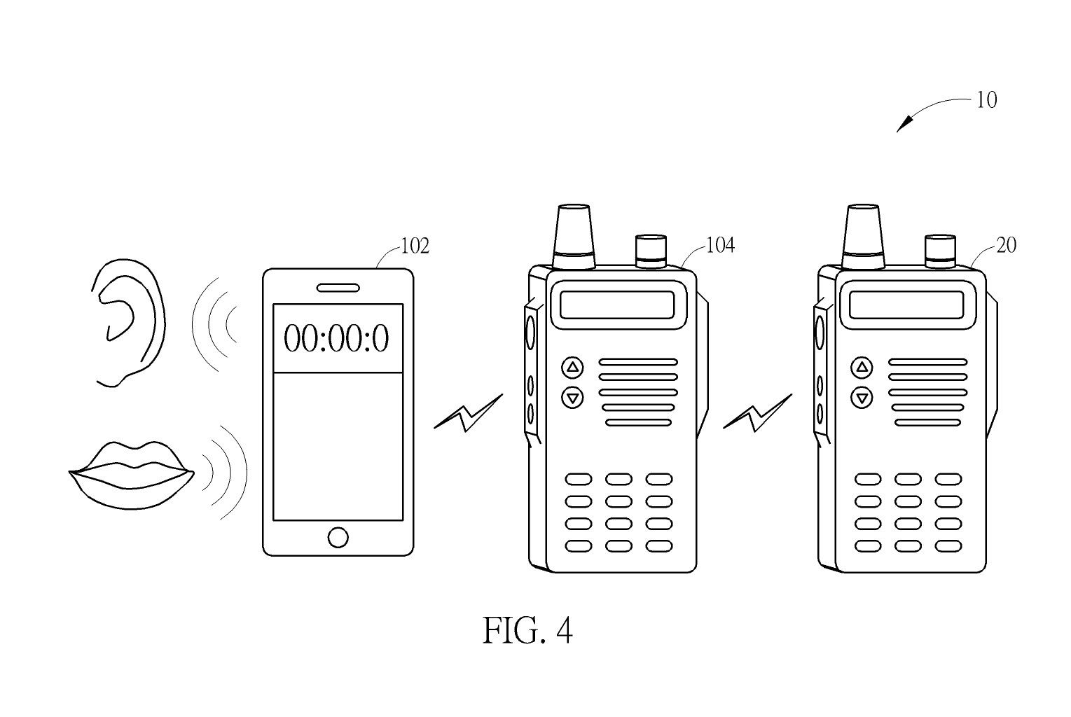

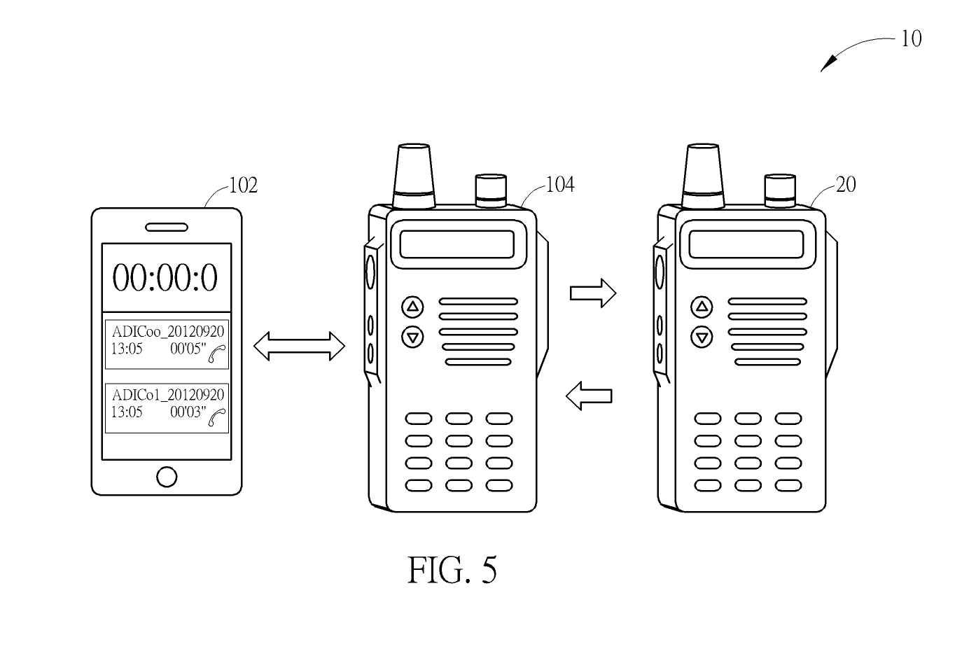

Please refer to FIG. 4, which illustrates a schematic diagram of another signal transmission between the mobile device 102 and the radio device 104 according to an embodiment of the invention. As shown in FIG. 4, the signal processing module 1020 of the mobile device 102 is further coupled to a dialing history record module (not shown in the figure), or those skilled in the art can directly integrate the dialing history record module into the signal processing module 1020, and the display panel of the mobile device 102 can be utilized to display related operations of the dialing history record module. Preferably, the dialing history record module, by pressing related buttons shown on the user interface 1022, can be utilized to record a dialing information, a date information, a user information of the real-time communication module 1042 for bridging the mobile device 102 and the radio device 104, or record related information, such as a user identity or a utilizing operational frequency range, of another radio device 20 communicating with the radio device 104. Please refer to FIG. 5, which illustrates a schematic diagram of utilizing a dialing history record module for recording the communication of the mobile device 102 and the radio device 104 according to an embodiment of the invention. As shown in FIG. 5, the display panel of the mobile device 102 demonstrates an example of a history of communication between the radio devices 104 and 20. In detail, symbols for the radio device 104 and 20 are ADIC00 and ADIC01, respectively, and related periods as well as dates of the communications between the radio devices 104 and 20 can be adaptively recorded and shown on the display panel, such that more request services from other users can be achieved.

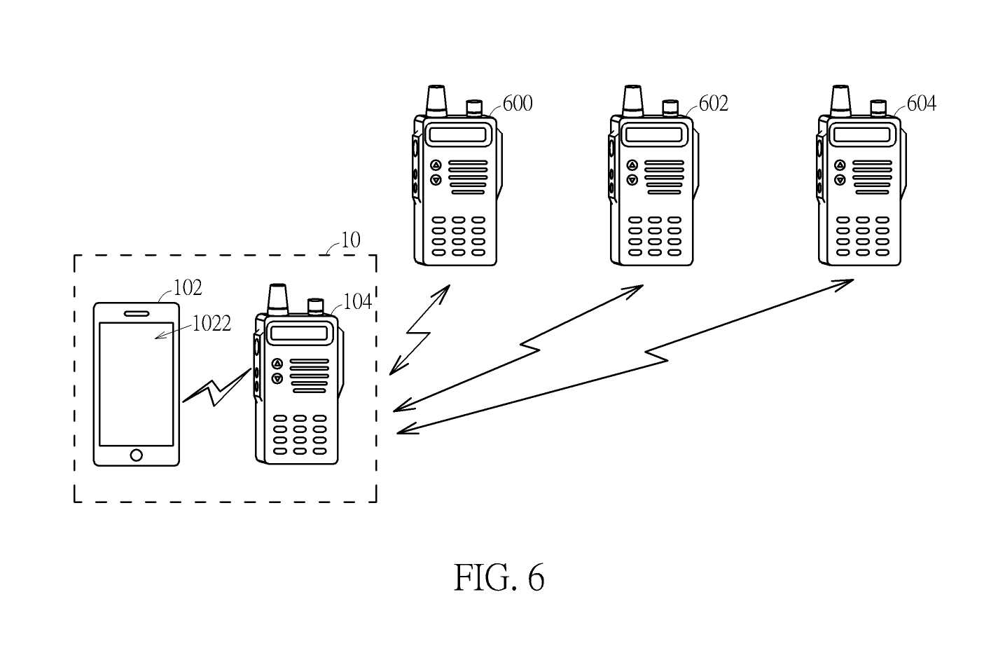

Please refer to FIG. 6, which illustrates a schematic diagram of a signal transmission between the smart radio system 10 and other radio devices 600, 602 and 604 according to an embodiment of the invention. As shown in FIG. 6, the radio devices 600, 602 and 604 can utilize a particular transmission frequency or a reception of broadcasting signals to receive the wireless transmission signal generated by the mobile device 102 and the radio device 104. In other words, the real-time communication module 1042 of the radio device 104 can be utilized to process the real-time and two-way communication with the radio devices 600, 602 and 604. Besides, the signal processing module 1020 of the invention is further coupled to a location module (not shown in the figure), and those skilled in the art can directly integrate the location module into the signal processing module 1020, such that the location module can be utilized to locate/sense a location information of the smart radio system 10. Further, each of the radio devices 600, 602 and 604 includes a processing module (or installing another location module) being capable of recognizing the location information, to correspondingly receive the location information of the smart radio system 10, so as to determine the location information of the user while the user is utilizing the smart radio system 10.

Moreover, the location module of one of the radio devices 600, 602 and 604 can transmit the location information to the radio device 104, and then transmit the location information to the mobile device 102. The mobile device 102 can pre-store a predetermined map information or an on-line map information, such as a Google map, to determine the location information of the radio devices 600, 602 and 604. In short, the smart radio system 10 of the invention can determine its location information and the location information associated with other radio devices being communicated with the smart radio system 10, and the smart radio system 10 can also transmit the location information thereof to other radio devices, such that the smart radio system 10 and the other radio devices can establish the real-time and two-way communication with the location information. Also, the real-time and two-way communication provides the user more advantages to be applied to different activities/applications, such as a public safe activity, a rescue activity, a military activity or an outdoor recreation, which is also in the scope of the invention. The embodiment of the invention is not limiting the mobile device 102 to pre-storing the predetermined map information or the on-line map information, and those skilled in the art can adaptively apply the similar concept to the radio device 104, i.e. the radio device 104 can also pre-store the predetermined map information or the on-line map information, which is also in the scope of the invention.

Furthermore, the signal processing module 1020 of the invention is further coupled to a detection module (not shown in the figure), or those skilled in the art can directly integrate the detection module into the signal processing module 1020, such that the detection module can be utilized to detect an environmental condition, comprising a height information, a temperature information, a humidity information or a user body information, of the smart radio system 10 to transmit the environmental condition to other radio devices being capable of recognizing the environmental condition, such as the radio devices 600, 602 and 604 installing the related processing module(s), so as to process related request services, which is not limiting the scope of the invention.

Noticeably, the smart radio system 10 of the invention can be applied to a lone user while being in the forest, such as a meteorology worker, a lumberman, a fireman. Accordingly, the mobile device 102 of the smart radio system 10 periodically transmits a hint signal to be transmitted to other radio devices (e.g. the radio devices 600, 602 and 604 shown in FIG. 6) via the radio device 104, and the radio devices 600, 602 and 604 can also transmit a recognition signal to respond to the hint signal generated by the smart radio system 10, such that the user utilizing the radio devices 600, 602 and 604 can inform the smart radio system 10 of a safe situation. Otherwise, if the radio devices 600, 602 and 604 fail to transmit the recognition signal to the smart radio system 10, the smart radio system 10 can determine that the user utilizing the radio devices 600, 602 and 604 is in a dangerous situation, such that related crews can be sent for rescue in time. In short, the recognition signal of the invention can be utilized to represent an alive information of the user. When the user is capable of periodically transmitting the recognition signal to the smart radio system 10, the safe situation of the user is determined. Otherwise, the dangerous situation of the user occurs, which can also be utilized to timely inform the related authorities for rescue, and is not limiting the scope of the invention.

The mobile device 102, the radio device 104 or the external radio devices 600, 602 and 604 of the invention can further include an emergency module (not shown in the figure), and the emergency module predetermines several determined conditions, e.g. whether, beyond a predetermined period, the user tilts the emergency module (or the mobile device 102, the radio device 104 or the external radio devices 600, 602 and 604) over a predetermined angle or positions the emergency module to have an angle being larger than a normal/regular angle between the emergency module and a reference ray. In the meanwhile, if the user is not able to transmit the recognition signal, the emergency module can correspondingly generate an emergency signal to inform one of the mobile device 102, the radio device 104 or the external radio devices 600, 602 and 604, so as to inform the user of an emergency event occurring, Accordingly, an elimination operation is necessary to rule out the emergency event.

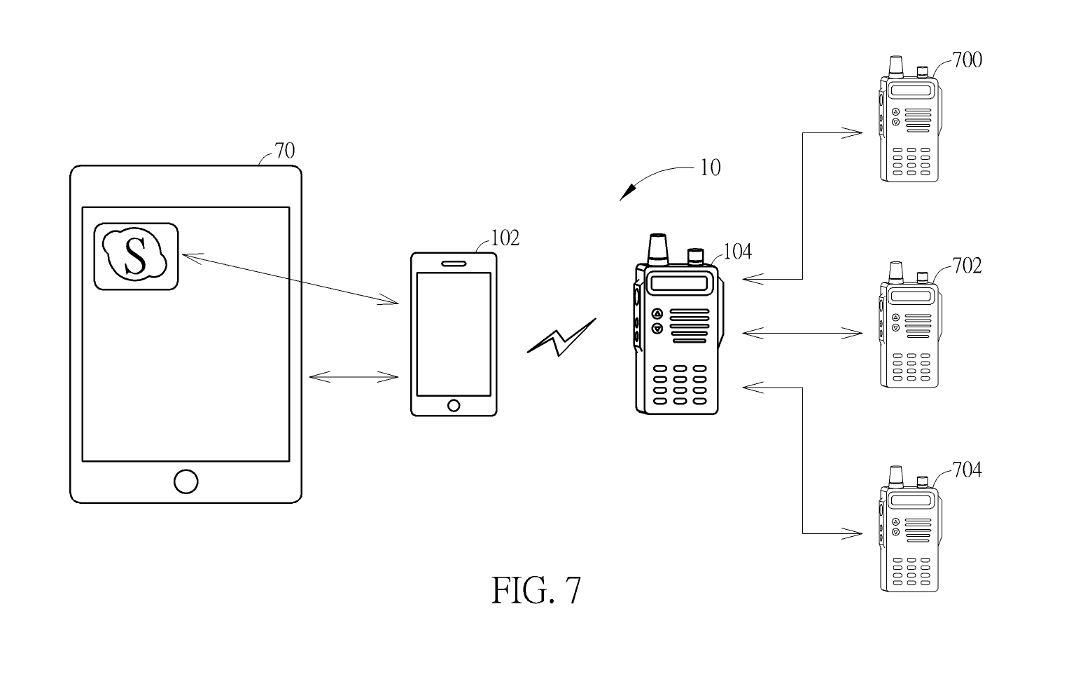

Please refer to FIG. 7, which illustrates a schematic diagram of another signal transmission between the smart radio system 10 and other radio devices 700, 702 and 704 according to an embodiment of the invention. As shown in FIG. 7, the signal processing module 1020 of the mobile device 102 is further coupled to a network module (not shown in the figure), or those skilled in the art can directly integrate the network module into the signal processing module 1020, such that the network module can be utilized to connect a mobile communication network, so as to connect another mobile device, such as a panel device 70. Accordingly, the mobile device 102 and the panel device 70 can utilize the mobile communication network to interchange the digital information, and both can install the same application, such as the network phone application as Skype or a social application as Facebook, to utilize the application for interchanging the digital information, which is also in the scope of the invention. The smart radio system 10 is further coupled to the radio devices 700, 702 and 704 being capable of recognizing the digital information, such that the mobile device 102 can transmit the digital information from the panel device 70 to the radio devices 700, 702 and 704 via the radio device 104, to establish the two-way communication between the radio devices 700, 702 and 704, the smart radio system 10 and the panel device 70.

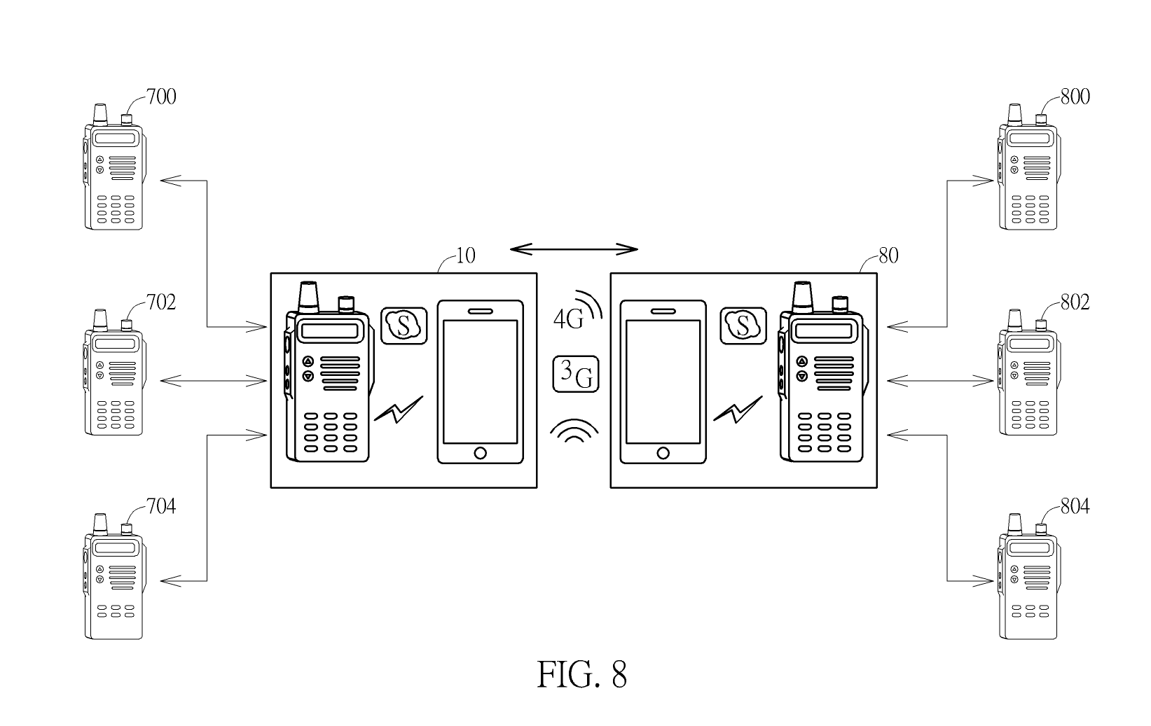

Please refer to FIG. 8, which illustrates a schematic diagram of a signal transmission between different smart radio systems 10 and 80 according to an embodiment of the invention. As shown in FIG. 7 and FIG. 8, the smart radio system 80 has the same composition of elements of the smart radio systems, i.e. both the smart radio systems 10, 80 have the radio device being wireless/wired coupled to the mobile device. Besides, the smart radio system 80 is further coupled to radio devices 800, 802 and 804. Under such circumstance, the smart radio systems 10, 80 of the invention can utilize different wireless transmission techniques, such as the third generation or the fourth generation mobile communication system or the Wireless Fidelity (WiFi), to establish the two-way communication of the smart radio systems 10, 80. Accordingly, the radio devices 700, 702 and 704 coupled to the smart radio system 10 and the radio devices 800, 802 and 804 coupled to the smart radio system 80 can communicate to each other or interchange related information via the real-time communication.

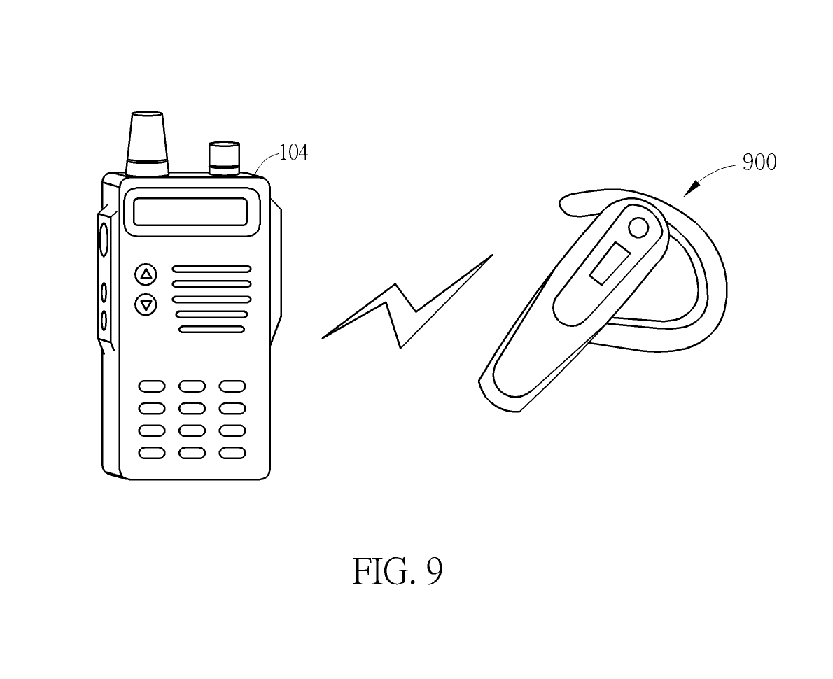

Please refer to FIG. 9, which illustrates a schematic diagram of a radio device 104 and a Bluetooth module 900 according to an embodiment of the invention. As shown in FIG. 9, the radio device 104 and the mobile device 102 can utilize the Bluetooth technique to establish the wireless transmission. Accordingly, the radio device 104 is further coupled to a Bluetooth module 900, as a Bluetooth earphone shown in FIG. 9, and the radio device 104 can utilize the Bluetooth module 900 and the mobile device 102 to communicate with the external radio device via the two-way communication. Certainly, the Bluetooth module 900 of the embodiment can be utilized to connect to the mobile device 102, such that the mobile device 102 can utilize the radio device 104 to communicate with the external radio device via the two-way communication. Further, the radio device 104 includes a removable and chargeable battery to be a charging module, such that a power-consuming mobile device 102 can utilize the removable and chargeable battery of the radio device 104 for charging while the mobile device 102 connects to the radio device 104, which is also in the scope of the invention.

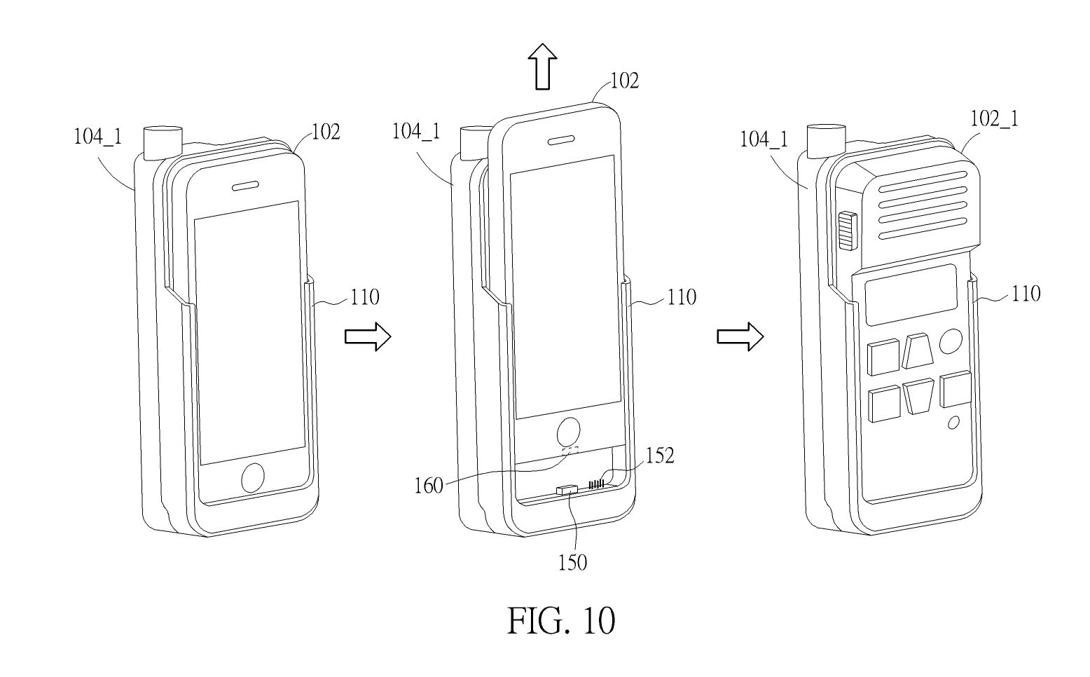

The embodiments shown in FIG. 2 to FIG. 9 are demonstrations for the smart radio system 10 of the invention, and are not limiting the scope of the invention that those skilled in the art can adaptively modify the demonstrations shown in FIG. 2 to FIG. 9 to integrate the cooperation of the mobile device as well as the radio device. For example, the operational interface of the radio device can be replaced by the user interface of the mobile device. Please refer to FIG. 10, which illustrates a schematic diagram of combination of the mobile device 102 and the radio device 104_1 according to an embodiment of the invention. As shown in FIG. 10, the radio device 104_1 includes a fixing unit 110 and an adapter 150. The fixing unit 110 can be a housing of the radio device 104_1 to dispose a socket or a slot, and the socket/slot has a shape and a disposition to match another housing of the mobile device 102, such that the mobile device 102 can be firmly fixed with fixing unit 110 of the radio device 104_1. The adapter 150 can be a father adapter (e.g. a Lightning port) to correspond to a connection port 160 of the mobile device 102. Under such circumstances, the mobile device 102 and the radio device 104_1 can further utilize the adapter 150, the connection port 160 to be mechanical fixed, such that the mobile device 102 can be adaptively fixed with the radio device 104_1, and the connection of the adapter 150 and the connection port 160 can also be utilized to provide an electrical transmission path. Further, the radio device 104_1 can also include another assistive adapter 152 as a plurality of metal ports, to provide another option for different designed connection ports corresponding to different removable display panel of the radio device, so as to provide structure fixing as well as signal transmission, which is also in the scope of the invention. Certainly, the mobile device 102 and the radio device 104_1 can modify/change/replace the current connection to be a removable VELCRO tape, a buckle, so as to tightly fix the mobile device 102 and the radio device 104_1 while operating the signal transmission between the mobile device 102 and the radio device 104_1, which is also in the scope of the invention.

Preferably, the embodiment of the invention is not limiting a design pattern of the user interface of the mobile device 102. In other words, according to different requirements, the user interface 1022 of the mobile device 102 can be designed to include a plurality of virtual buttons shown on the display panel, or the display panel of the mobile device 102_1 includes a plurality of practical buttons, which is also in the scope of the invention.

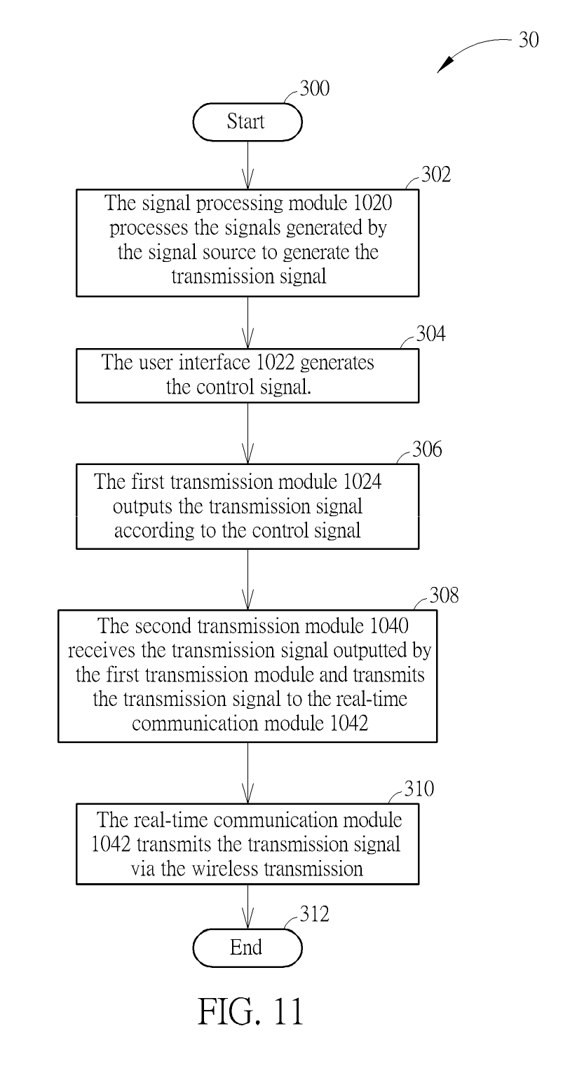

Further, the operation for the smart radio system 10 of the invention includes a first operation and a second operation, and both can be summarized as a first operation process 30 and a second operation process 40 to be compiled as programming codes and stored in a storage module of the mobile device 102, as shown in FIG. 11. The first operation process 30 includes the following steps:

Step 300: Start.

Step 302: The signal processing module 1020 processes the signals generated by the signal source to generate the transmission signal.

Step 304: The user interface 1022 generates the control signal.

Step 306: The first transmission module 1024 outputs the transmission signal according to the control signal.

Step 308: The second transmission module 1040 receives the transmission signal outputted by the first transmission module and transmits the transmission signal to the real-time communication module 1042.

Step 310: The real-time communication module 1042 transmits the transmission signal via the wireless transmission.

Step 312: End.

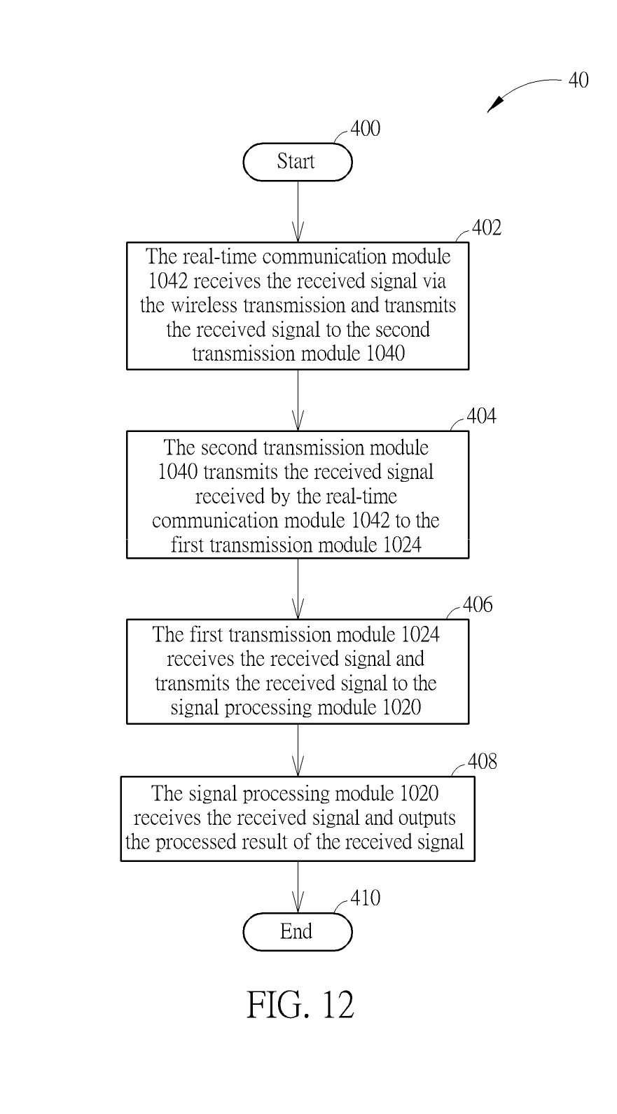

Further, as shown in FIG. 12, the second operation process 40 includes the following steps:

Step 400: Start.

Step 402: The real-time communication module 1042 receives the received signal via the wireless transmission and transmits the received signal to the second transmission module 1040.

Step 404: The second transmission module 1040 transmits the received signal received by the real-time communication module 1042 to the first transmission module 1024.

Step 406: The first transmission module 1024 receives the received signal and transmits the received signal to the signal processing module 1020.

Step 408: The signal processing module 1020 receives the received signal and outputs the processed result of the received signal.

Step 410: End.

Details of the first operation process 30 and the second operation process 40 can be understood via the embodiments shown from FIG. 1 to FIG. 10 and related paragraphs thereof, which is not described hereinafter for brevity. Preferably, the embodiment of the invention utilizes the mobile device 102 for processing the first operation process 30 and the second operation process 40 to control the coupled radio device 104. Certainly, those skilled in the art can adaptively modify the same conception to have the partial programming codes being separately stored in storage modules of the mobile device 102 and the radio device 104, respectively, so as to lower the transmission period and save the transmission power (i.e. elevating the transmission efficiency), which is also in the scope of the invention.

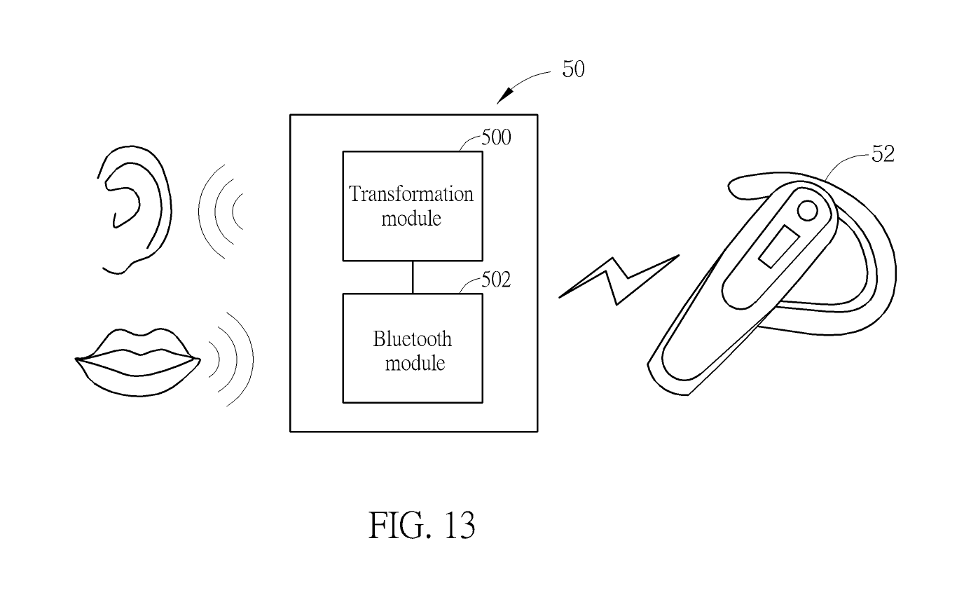

Please refer to FIG. 13, which illustrates a schematic diagram of another radio system 50 being capable of integrating with the smart radio system 10 according to an embodiment of the invention. As shown in FIG. 13, the radio system 50 can be coupled to a Bluetooth earphone module 52 via a wireless transmission way, and includes a transformation module 500 and a Bluetooth module 502. In the embodiment, the transformation module 500 can be utilized to receive an audio signal (i.e. the transformation module 500 receiving an analog signal), so as to generate a transformation signal (i.e. the transformation module 500 transforming the analog signal to be a digital signal). The Bluetooth module 502 can be utilized to receive the transformation signal to generate a Bluetooth transmission signal to the Bluetooth earphone module 52, such that the Bluetooth earphone module 52 correspondingly obtains the audio signal being transformed. Preferably, the audio signal can be a voice signal and the Bluetooth transmission signal can be the transformed voice signal, and the Bluetooth earphone module 52 can re-transform the Bluetooth transmission signal to be the voice signal again, such that the user can listen to the voice signal.

Noticeably, the radio system 50 of the invention can be a digital radio system or an analog radio system, and the radio system 50 includes the basic transmission/reception operation of the radio device 104 of the smart radio system 10, i.e. the radio system 50 also includes the real-time communication module 1042 of the radio device 104 to be coupled to the transformation module 500. For simplicity, the related description/demonstration is not mentioned hereinafter. Particularly, the transformation signal processed by the transformation module 500 can be a digital input signal or an analog input signal. The radio system 50 also includes a user interface virtually disposing a dialing button (or a PTT button). When the dialing button is pressed once and then released, the radio system 50 can initiate a communication operation to communicate with an external radio device via the real-time communication. When the dialing button is pressed twice and then released, the radio system 50 terminates the communication operation as well as the real-time communication with the external radio device.

In other words, the radio system 50 of the invention can integrate the Bluetooth technique to process the wireless transmission operation in the short-distance transmission, so as to facilitate the user while operating the radio system 50 and to prevent the user from holding the operating radio system 50. Since the Bluetooth technique is cooperated/integrated in the radio system 50, a distortion of the transmission signal can be adaptively reduced while the radio system 50 communicates with the external radio device, and the power consumption of the internally installed Bluetooth module 502 can be reduced as well.

Certainly, the radio system 50 can adaptively modify the setting of the dialing button (or the PTT button) according to different operational habits. For example, when the user presses the dialing button without releasing, the radio system 50 can initiate the communication operation to communicate with the external radio device via the real-time communication; when the user stops pressing the dialing button and releases the dialing button, the radio system 50 can terminate the communication operation and the real-time communication with the external radio device. Further, a pressing number of the dialing button can be adaptively designed/modified to initiate or terminate the communication operation, which is also in the scope of the invention.

Noticeably, those skilled in the art can integrate the radio system 50 in the smart radio system 10, such that the radio system 50 and the mobile device 102 can be electrically connected, or the radio system 50 can utilize the mobile communication network to connect to different radio devices or smart radio systems, which is also in the scope of the invention.

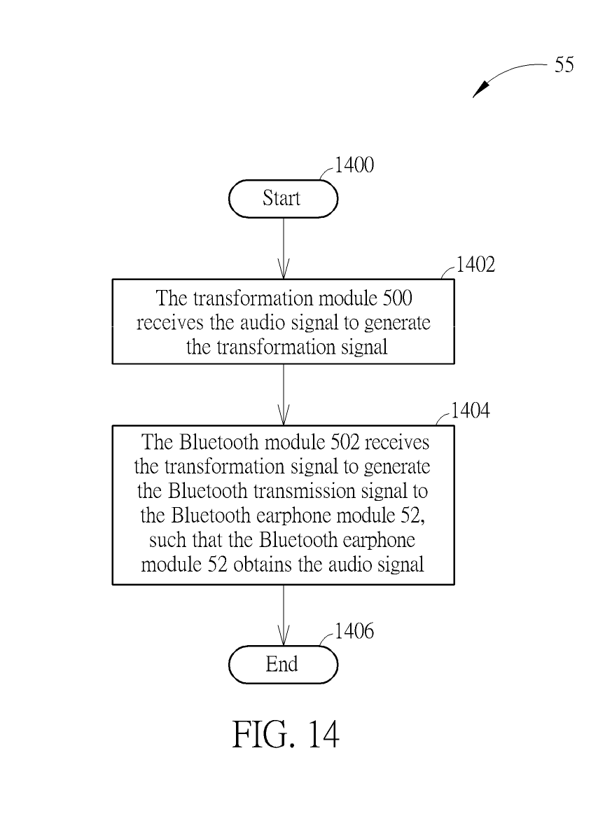

Further, the operation for the radio system 50 of the invention can be summarized as an operation process 55 to be compiled as programming code and stored in a storage module of the radio system 55, as shown in FIG. 14. The operation process 55 includes the following steps:

Step 1400: Start.

Step 1402: The transformation module 500 receives the audio signal to generate the transformation signal.

Step 1404: The Bluetooth module 502 receives the transformation signal to generate the Bluetooth transmission signal to the Bluetooth earphone module 52, such that the Bluetooth earphone module 52 obtains the audio signal.

Step 1406: End.

Details of the operation process 55 can be understood via the embodiments shown in FIG. 13 and related paragraphs, which is not described hereinafter for brevity. Certainly, those skilled in the art can adaptively modify the operation process 55 to cooperate with the first operation process 30 and the second operation process 40, such that the radio system 50 and the smart radio system 10 can adaptively communicate with each other via the real-time communication, which is also in the scope of the invention.

In summary, the embodiment of the invention provides a smart radio system integrating a mobile device as well as a radio device. The mobile device and the radio device are coupled to each other via a wireless/wired transmission way, and the smart radio system is further coupled to other radio devices or mobile devices for processing the real-time communication. Besides, the embodiment of the invention provides a radio system to integrate a Bluetooth earphone module and a Bluetooth module for processing the short-distance transmission, so as to lower the distortion of the transmission signal and power consumption of the radio system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A smart radio system, comprising:
a mobile device, comprising:
a signal processing module for processing a received signal to output a processed result of the received signal, or processing signals generated by a signal source to generate a transmission signal;
a user interface for generating a control signal; and
a first transmission module, coupled between the user interface and the signal processing module, for receiving the received signal to be transmitted to the signal processing module, or outputting the transmission signal according to the control signal; and
a radio device, comprising:
a real-time communication module for receiving the received signal or transmitting the transmission signal via a wireless transmission; and
a second transmission module, coupled between the real-time communication module and the first transmission module, for transmitting the transmission signal outputted by the first transmission module to the real-time communication module, or transmitting the received signal received by the real-time communication module to the first transmission module.

2. The smart radio system of claim 1, wherein the first transmission module is coupled to the second transmission module via a wireless transmission way.

3. The smart radio system of claim 2, wherein the first transmission module is coupled to the second transmission module via a Bluetooth technique.

4. The smart radio system of claim 1, wherein the first transmission module is coupled to the second transmission module via a wired transmission way.

5. The smart radio system of claim 1, wherein the radio device further comprises a fixed unit and/or an adapter for fixing the mobile device.

6. The smart radio system of claim 5, wherein a shape and a position of the adapter is designed to match a connector of the mobile device, such that the mobile device is fixed with the radio device via the connector and the adapter.

7. The smart radio system of claim 1, wherein the user interface comprises a touch panel and at least one virtual button displayed on the touch panel, and the at least one virtual button generates the control signal while being touched.

8. The smart radio system of claim 7, wherein the user interface further comprises a frequency adjustment unit displayed on the touch panel, and the frequency adjustment unit is utilized for adjusting an operational frequency of the real-time communication module.

9. The smart radio system of claim 7, wherein the user interface further comprises an audio adjustment unit displayed on the touch panel, and the audio adjustment unit is utilized for adjusting an outputted audio volume of the signal processing module.

10. The smart radio system of claim 1, wherein the signal processing module is further coupled to a dialing history record module to record a dialing information, a date information, a user information or related information of another being dialed radio device of the real-time communication module.

11. The smart radio system of claim 1, wherein the signal processing module is further coupled to a location module to locate a location information of the smart radio system, so as to transmit the location information to another radio device being capable of recognizing the location information.

12. The smart radio system of claim 11, wherein the location module utilizes a predetermined map information to recognize the location information, so as to record a movement information of the smart radio system.

13. The smart radio system of claim 1, wherein the signal processing module is further coupled to a detection module to detect an environmental condition of the smart radio system, so as to transmit the environmental condition to another radio device being capable of recognizing the environmental condition, wherein the environment condition comprises a height information, a temperature information, a humidity information or a user body information.

14. The smart radio system of claim 1, wherein the mobile device periodically transmits a hint signal to an external radio device, and the external radio device correspondingly transmits a recognition signal to respond the mobile device.

15. The smart radio system of claim 14, wherein the recognition signal is generated by a touch of a user to represent an alive information of the user.

16. The smart radio system of claim 14, wherein the external radio device further comprises an emergency module to generate an emergency signal to the mobile device, so as to inform the mobile device an emergency event.

17. The smart radio system of claim 1, wherein the radio device or the mobile device further comprises an emergency module to generate an emergency signal.

18. The smart radio system of claim 1, wherein the signal processing module is further coupled to a network module to connect a mobile communication network, so as to communicate with another external mobile device.

19. The smart radio system of claim 18, wherein the radio device further utilizes the network module to communicate with the external mobile device via a two-way communication.

20. The smart radio system of claim 18, wherein the mobile device further utilizes the network module to communicate with an external smart radio system via a two-way communication.

21. The smart radio system of claim 1, wherein the radio device further comprises a charging module, such that the mobile device utilizes the charging module for charging.

22. The smart radio system of claim 1, wherein the radio device or the mobile device is further coupled to a Bluetooth module, such that the radio device or the mobile device communicates with an external radio device via a real-time two-way communication.

23. A method for operating a smart radio system, which comprises a radio device and a mobile device and both are coupled to each other, the method comprising a first operation and a second operation, the first operation comprising:
a signal processing module of the mobile device processing signals generated by a signal source to generate a transmission signal;
a user interface of the mobile device generating a control signal;
a first transmission module outputting the transmission signal according to the control signal;
a second transmission module of the radio device receiving the transmission signal outputted by the first transmission module, and transmitting the transmission signal to a real-time communication module of the radio device; and
the real-time communication module transmitting the transmission signal via a wireless transmission; and
the second operation comprising:
the real-time communication module receiving the received signal, and transmitting the received signal to the second transmission module;
the second transmission module transmitting the received signal received by the real-time communication module to the first transmission module;
the first transmission module receiving the received signal, and transmitting the received signal to the signal processing module; and
the signal processing module receiving the received signal, and outputting a processed result of the received signal.

24. The method of claim 23, wherein the first transmission module is coupled to the second transmission module via a wireless transmission way.

25. The method of claim 24, wherein the first transmission module is coupled to the second transmission module via a Bluetooth technique.

26. The method of claim 23, wherein the first transmission module is coupled to the second transmission module via a wired transmission way.

27. The method of claim 23, further comprising utilizing a fixed unit and/or an adapter of the radio device to fix the mobile device.

28. The method of claim 27, further comprising designing a shape and a position of the adapter to match a connector of the mobile device, such that the mobile device is fixed with the radio device via the connector and the adapter.

29. The method of claim 23, further comprising utilizing a touch panel of the user interface and at least one virtual button displayed on the touch panel to generate the control signal while the at least one virtual button being touched.

30. The method of claim 29, further comprising utilizing a frequency adjustment unit displayed on the touch panel to adjust an operational frequency of the real-time communication module.

31. The method of claim 29, further comprising utilizing an audio adjustment unit displayed on the touch panel to adjust an outputted audio volume of the signal processing module.

32. The method of claim 23, further comprising utilizing a dialing history record module to record a dialing information, a date information, a user information or related information of another being dialed radio device of the real-time communication module.

33. The method of claim 23, further comprising utilizing a location module to locate a location information of the smart radio system, so as to transmit the location information to another radio device being capable of recognizing the location information.

34. The method of claim 33, further comprising utilizing a predetermined map information to recognize the location information, so as to record a movement information of the smart radio system.

35. The method of claim. 23, further comprising utilizing a detection module to detect an environmental condition of the smart radio system, so as to transmit the environmental condition to another radio device being capable of recognizing the environmental condition, wherein the environment condition comprises a height information, a temperature information, a humidity information or a user body information.

36. The method of claim 23, wherein the mobile device periodically transmits a hint signal to an external radio device, and the external radio device correspondingly transmits a recognition signal to respond the mobile device, wherein the recognition signal is generated by a touch of a user to represent an alive information of the user.

37. The method of claim 36, further comprising utilizing an emergency module of the external radio device to generate an emergency signal to the mobile device, so as to inform the mobile device an emergency event.

38. The method of claim 23, further comprising utilizing an emergency module of the radio device or the mobile device to generate an emergency signal.

39. The method of claim 23, further comprising utilizing a network module of the mobile device to connect a mobile communication network, so as to communicate with another external mobile device.

40. The method of claim 39, wherein the radio device or the mobile device further utilizes the network module to communicate with the external mobile device via a two-way communication.

41. The method of claim 23, further comprising utilizing a charging module of the radio device to charge the mobile device.

42. The method of claim 23, further comprising utilizing a Bluetooth module of the radio device or the mobile device to communicate with an external radio device via a real-time two-way communication.

43. A radio system coupled to a Bluetooth earphone module, the radio system comprising:
a transformation module for receiving an audio signal to generate a transformation signal; and
a Bluetooth module for receiving the transformation signal to generate a Bluetooth transmission signal to the Bluetooth earphone module, such that the Bluetooth earphone module obtains the audio signal.

44. The method of claim 43, wherein the radio system is realized as a digital radio system or an analog radio system, and the transformation signal is correspondingly realized as a digital input signal or an analogy input signal.

45. The method of claim 43, further comprising a user interface disposing a dialing button, and when the dialing button is pressed once and then released, a real-time communication is initiated; and when the dialing button is pressed twice and then released, the real-time communication is terminated.

46. A method for a radio system, which is coupled to a Bluetooth earphone module and comprises a transformation module and a Bluetooth module, the method comprising:
the transformation module receiving an audio signal to generate a transformation signal; and
the Bluetooth module receiving the transformation signal to generate a Bluetooth transmission signal to the Bluetooth earphone module, such that the Bluetooth earphone module obtains the audio signal;
wherein the transformation signal is realized as a digital input signal or an analogy input signal.

47. The method of claim 46, further comprising utilizing a dialing button, and when the dialing button is pressed once and then released, a real-time communication is initiated; and when the dialing button is pressed twice and then released, the real-time communication is terminated.
